(19) United States
(12) Patent Application Publication
(10) Pub. No.: US 2024/0308003 A1
(43) Pub. Date: Sep. 19, 2024

(54) METHOD FOR CUTTING AN AMORPHOUS METAL ALLOY SAMPLE

(71) Applicants: VULKAM, Gières (FR); LASER ENGINEERING APPLICATIONS, Seraing (BE)

(72) Inventors: Sébastien GRAVIER, Murianette (FR); Sarah ABRAHAM, Grenoble (FR); Xavier CERUTTI, Saint Egreve (FR); Léo LEBRUN, Villenave d'Ornon (FR); Mathieu DIJOUX, Begles (FR)

(73) Assignees: VULKAM, Gières (FR); LASER ENGINEERING APPLICATIONS, Seraing (BE)

(21) Appl. No.: 18/575,070

(22) PCT Filed: Jun. 29, 2022
(86) PCT No.: PCT/EP2022/067826

§ 371 Date: Dec. 28, 2023

(30) Foreign Application Priority Data
Jun. 30, 2021 (FR) FR2107113

(51) Int. Cl. B23K 26/38; B23K 26/0622; B23K 26/08; B23K 103/18

(52) U.S. Cl. CPC B23K 26/38; B23K 26/0624; B23K 26/08; B23K 2103/26

(57) ABSTRACT

A method for machining a sample of amorphous metal alloy using a femtosecond laser, including at least one step of irradiating the sample with a laser beam along a reference trajectory to ablate material from the sample, so as to obtain a sample machined and maintained in the amorphous state, in which, the laser beam is pulsed, and the duration of each pulse is less than 1000 femtoseconds, preferably less than 600 femtoseconds, and in which the amorphous metal alloy has a critical diameter less than 5 millimeters, and/or a difference between the crystallization temperature and the glass transition temperature less than 60° C., and/or a quotient of the difference between the crystallization temperature and the glass transition temperature and of the difference between the liquidus temperature and the temperature glass transition is less than 0.12.

### TECHNICAL FIELD

The present invention relates to the field of methods for machining metal microcomponents, in particular amorphous metal alloy (AMA) parts. Indeed, amorphous alloys present mechanical characteristics that are particularly interesting for technical fields involving very small parts.

### PRIOR ART

It is known to obtain amorphous metal preforms by injection into molds of a specific shape. By cooling the injected metal quickly enough, the crystallization of the alloy can be avoided and an amorphous structure can be obtained. This type of amorphous alloy structure is also called metallic glass.

In order to obtain a mechanical part ready to be integrated, for example, into a watch mechanism, it is sometimes necessary to machine the molded pr

In the general field of alloys, in particular crystalline alloys, numerous machining and/or shaping techniques have been developed (stamping, micro-milling, etc.). However, these techniques cannot be easily transposed to AMAs which have particular chemical compositions and mechanical properties generally much higher than crystalline alloys. The machining is therefore more complex to master (obtaining the desired precision and surface finish, perpendicularity of the sides, tool life, production speed compatible with industrial constraints, etc.).

However, many of these techniques cause thermal heating at the level of the machined zones, thus implying a local recrystallization of the alloy and the loss of the amorphous structure of the AMA at the level of the machined zones. This is all the more true for AMAs with low thermal stability. Indeed, among the AMAs, some have lower thermal stability than others. This low thermal stability reflects the ease/rapidity with which the structure of the alloy can be affected by a temperature variation (temperature increase beyond the glass transition temperature Tg, too slow cooling, etc.). The AMAs with lower thermal stability therefore have an ability to evolve towards a crystalline state more quickly above the glass transition temperature Tg.

Laser cutting methods are suitable for the manufacture of microcomponents, in particular microcomponents made of crystalline metal alloys. As indicated previously, the latter are however much less sensitive to temperature than AMAs, in particular than AMAs with low thermal stability.

Thus, the difficulty is to carry out these machining operations of the AMAs while retaining their amorphous structure, by guaranteeing a quality of the surface condition of the machined part and by maintaining a high cycle time adapted to an industrial production. Indeed, a machining operation which would lead to excessive heating of the material would cause a crystallization of the heat-affected zone and therefore lose the advantageous properties conferred by the amorphous structure of the material. Conversely, imagining a laser machining method leaving long cooling times between two laser pulses is not compatible with an industrial production.

There is therefore a need to have a machining method that makes it possible to maintain an amorphous microstructure while authorizing an industrial-level manufacturing rate. Another requirement is to be able to obtain a surface condition with very low roughness and/or excellent perpendicularity of the sides in the cutting zone, in order to fully exploit the intrinsic qualities of the AMA.

### SUMMARY

To this end, the invention proposes a method for machining an amorphous metal alloy sample using a femtosecond laser, comprising at least one step of irradiating the sample with a laser beam along a reference trajectory to ablate material from the sample, in a through manner or not, along the reference trajectory so as to obtain a machined sample and maintained in an amorphous state, in which:
the laser beam is pulsed, and
the duration of each pulse is less than 1000 femtoseconds, preferably less than 600 femtoseconds, more preferably comprised between 100 femtoseconds and 600 femtoseconds.

According to an implementation mode, the laser beam is movable so as to be displaced relative to the sample to be machined along the reference trajectory.

Alternatively, the sample to be machined is movable so as to be displaced relative to the laser beam along the reference trajectory.

The amorphous metal alloy has:
a critical diameter less than 5 millimeters, preferably less than 3 millimeters, and/or
a difference between the crystallization temperature and the glass transition temperature less than 60° C., and/or
a quotient of the difference between the crystallization temperature and the glass transition temperature and of the difference between the liquidus temperature and the glass transition temperature less than 0.12, preferably less than 0.1.

These laser beam adjustment parameters make it possible to machine an amorphous sample and obtain a desired geometry while retaining the amorphous nature of the alloy structure. It is thus possible to obtain mechanical microcomponents with particularly interesting mechanical properties.

The characteristics listed in the following paragraphs can be implemented independently of each other or in all technically possible combinations:

According to an implementation mode of the method,
the laser beam is movable so as to be displaced relative to the sample to be machined along the reference trajectory; and
the pulsation frequency of the laser beam is greater than 1 kHz, preferably greater than 20 kHz; and
the scanning speed of the laser beam is less than 2000 mm/s, preferably less than 1000 mm/s and even more preferably less than 600 mm/s.

According to an embodiment, the laser beam may be an infrared laser beam, in particular an infrared laser beam having a wavelength comprised between 800 nm and 1100 nm, in particular a wavelength of 1030 nm±5 nm.

Alternatively, the laser beam may be a green laser beam, in particular a green laser beam having a wavelength comprised between 500 nm and 540 nm. The wavelength can in particular be equal to 515 nm±5 nm.

Even alternatively, the laser beam may be an ultraviolet laser beam, in particular an ultraviolet laser beam having a wavelength of less than 400 nm. The wavelength can in particular be equal to 343 nm±25 nm.

Even alternatively, the laser beam may be a blue laser beam, in particular a blue laser beam having a wavelength comprised between 400 nm and 480 nm.

According to an aspect of the method, the laser beam has a fluence greater than 15 J/cm2. Preferably, the fluence is greater than 20 J/cm2. The fluence can be in the range of 40 J/cm2 to 400 J/cm2.

According to an aspect of the method, each pulse of the laser beam irradiates a portion of the sample to be machined on the reference trajectory. The portion irradiated by a pulse at least partially covers the portion irradiated by the previous pulse. The overlap between two portions irradiated by two successive pulses of the laser beam is at least 25% of the surface diameter of a portion irradiated by the laser beam. The overlap between two portions irradiated by two successive pulses of the laser beam is at most 95% of the surface diameter of a portion irradiated by the laser beam.

According to an implementation mode of the method, the step of irradiating the sample with a laser beam along the reference trajectory (TRef) is iterated at least once. This step is preferably iterated at least 100 times, and more preferably at least 300 times. The reference trajectory (TRef_p) during an iteration (R_p) is merged with the reference trajectory (TRef_p−1) of the previous iteration (R_p−1).

According to an aspect of the method, the laser beam has a diameter projected onto the irradiated portion of the sample less than 100 μm, preferably comprised between 5 and 100 μm, preferably comprised between 10 to 60 μm, more preferably comprised between 10 and 30 μm.

The laser beam has an average power greater than 0.4 W. The average power is preferably greater than 1.5 W. The average power is more preferably comprised between 1.5 W and 30 W.

According to an implementation mode of the method, the displacement of the laser beam comprises a precession movement. A precession angle of the laser beam is less than 10°, preferably less than 8°.

According to an embodiment, an angle between the average direction of the laser beam and the direction normal to the surface of the irradiated portion of the sample is less than 10°, preferably less than 8°.

According to an aspect of the method, the laser beam has a variable focusing altitude. The focal plane altitude of the precession ring can be movable and is displaced towards the sample as the machining progresses; and/or the focal plane altitude of the individual beam may be displaced toward the sample or within the sample as the machining progresses;
the focusing altitude at the start of the machining being comprised between the altitude of the focal plane of the precession ring and the altitude of the focal plane of the individual beam.

According to an implementation example, the machining method is carried out by the implementation of at least one outline along at least one trajectory (TRef+n), n being the total number of implemented outlines, the method thus comprising:
optionally at least one step of irradiating (c) the sample with a laser beam along a reference trajectory (TRef+n) to ablate material from the sample, in a through manner or not, along the reference trajectory (TRef+n),
a step of irradiating (b) the sample with a laser beam along a reference trajectory (TRef+1) to ablate material from the sample, in a through manner or not, along the reference trajectory (TRef+1),
a step of irradiating (a) the sample with a laser beam along a reference trajectory (TRef) to ablate material from the sample, in a through manner or not, along the reference trajectory (TRef),
the reference trajectory (TRef+1) being adjacent to the reference trajectory (TRef) and translated by a given distance g1 from said reference trajectory (TRef); and
optionally, the reference trajectory (TRef+n) being adjacent to the reference trajectory (TRef+(n−1)) and translated by a given distance g2 from said reference trajectory (TRef+n−1) in the direction opposite to that of the trajectory (TRef), and
the given distances (g1, g2, gn) between two directly adjacent reference trajectories (TRef; TRef+1, TRef+(n−1); TRef+n) being such that the pulses of the laser beam, irradiating the sample to be machined on the first reference trajectory (TRef; TRef+1, TRef+(n−1) or TRef+n), also irradiates, at least partially, the sample to be machined on the reference trajectory(s) (TRef; TRef+1, TRef+(n−1) or TRef+n) which is or are directly adjacent to it.

The steps (a) and/or (b) and/or, optionally (c) can be repeated, preferably successively, until a machined part is obtained and maintained in an amorphous state.

According to an implementation example of the method, the amorphous metal alloy of the sample to be machined contains, in atomic percentage, more than 40% of Ni, Zr, Cu, Ti, Fe or Co. Preferably, the amorphous metal alloy of the sample to be machined contains, in atomic percentage, more than 50% of Ni, Zr, Cu, Ti, Fe or Co.

According to a variant, the amorphous metal alloy of the sample to be machined contains in atomic fraction more than 50% of the elements Ni and Nb. Preferably the amorphous metal alloy of the sample to be machined contains in atomic fraction more than 60% of the elements Ni and Nb, more preferably more than 70% of the elements Ni and Nb.

The invention also relates to a method for producing a surface of an amorphous metal alloy sample using a femtosecond laser, the method comprising at least one step of irradiating with a laser beam a first surface of the sample so as to obtain a second surface whose roughness Ra is less than 400 nm, preferably less than 200 nm, more preferably less than 100 nm; and in which:
the laser beam is pulsed, and
the duration of each pulse is less than 1000 femtoseconds, preferably less than 600 femtoseconds, more preferably comprised between 100 femtoseconds and 600 femtoseconds, and
in which:
the amorphous metal alloy has:
a critical diameter less than 5 millimeters, preferably less than 3 millimeters, and/or
a difference between the crystallization temperature and the glass transition temperature less than 60° C., and/or
a quotient of the difference between the crystallization temperature and the glass transition temperature and of the difference between the liquidus temperature and the glass transition temperature less than 0.12, preferably less than 0.1.

The invention also concerns a method for cutting an amorphous metal alloy sample using a femtosecond laser, the method comprising at least one step of irradiating with a laser beam a first surface of the sample on one face (F1) so as to obtain a second face (F2) such that at each point of intersection of the faces (F1) and (F2), said faces (F1) and (F2) form therebetween an angle of 90°±1.5°, preferably 90°±1°, more preferably 90°±0.5°; and in which:
the laser beam is pulsed, and
the duration of each pulse is less than 1000 femtoseconds, preferably less than 600 femtoseconds, more preferably comprised between 100 femtoseconds and 600 femtoseconds, and in which:
the amorphous metal alloy has:
a critical diameter less than 5 millimeters, preferably less than 3 millimeters, and/or
a difference between the crystallization temperature and the glass transition temperature less than 60° C., and/or
a quotient of the difference between the crystallization temperature and the glass transition temperature and of the difference between the liquidus temperature and the glass transition temperature less than 0.12, preferably less than 0.1.

The invention also relates to a method for manufacturing a part made of amorphous metal alloy, including the steps of:
melting a mixture of metals to obtain a piece of alloy,
injecting the piece obtained into a mold and cooling the molded alloy with a cooling speed greater than a critical speed of crystallization of the alloy, to obtain an amorphous alloy sample,
machining at least one surface of the sample according to the machining method previously described, or according to the method for producing a surface previously described, or according to the previous cutting method, to obtain an amorphous alloy part according to a predetermined geometry,
optionally carrying out a finishing step on at least the surface of the machined sample, preferably a tribofinishing step.

The invention also concerns a microcomponent, in particular a mechanical microcomponent, made of an amorphous metal alloy comprising at least one surface machined according to the machining method as described above, according to the method for producing a surface described previously or according to the cutting method described previously.

### BRIEF DESCRIPTION OF THE DRAWINGS

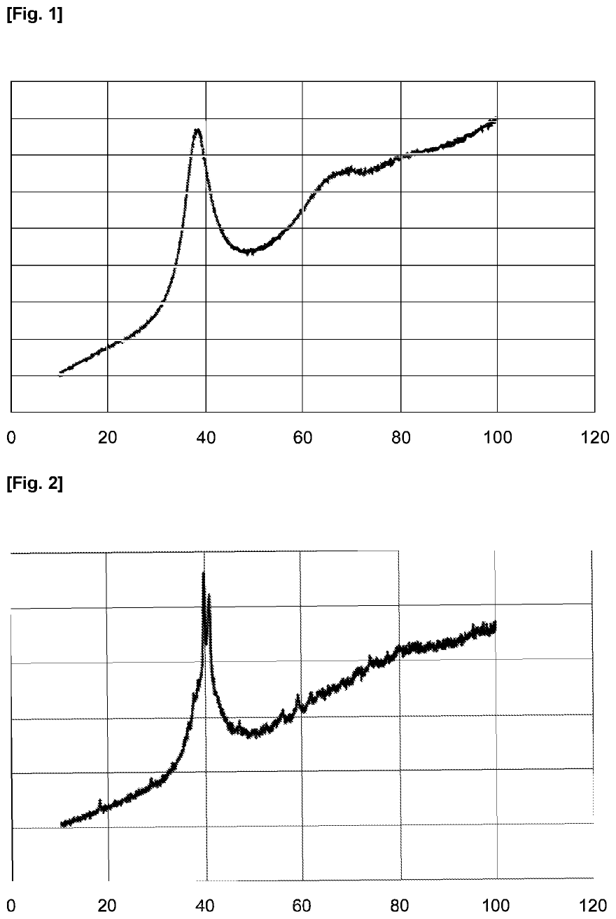

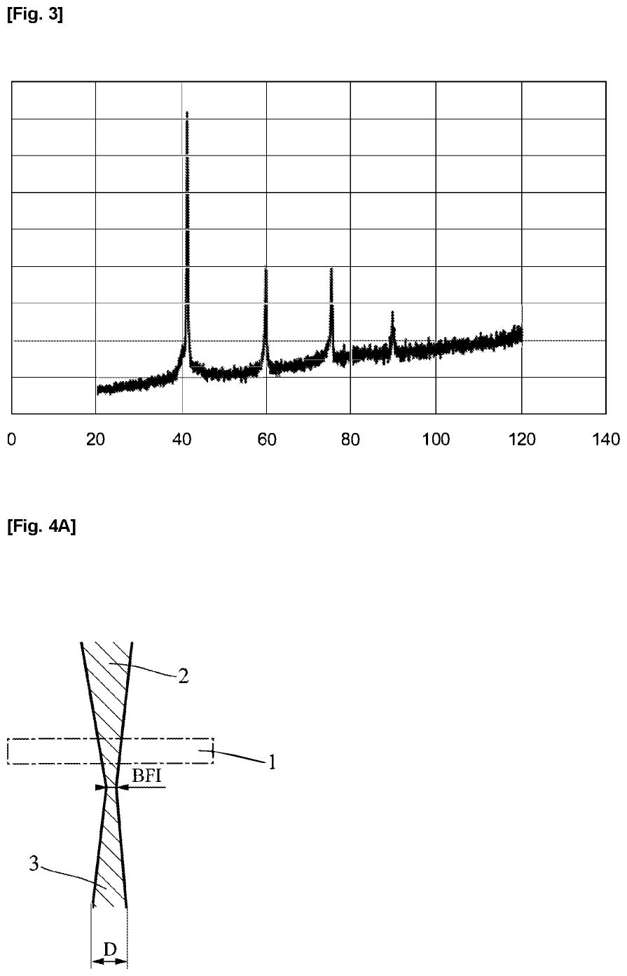

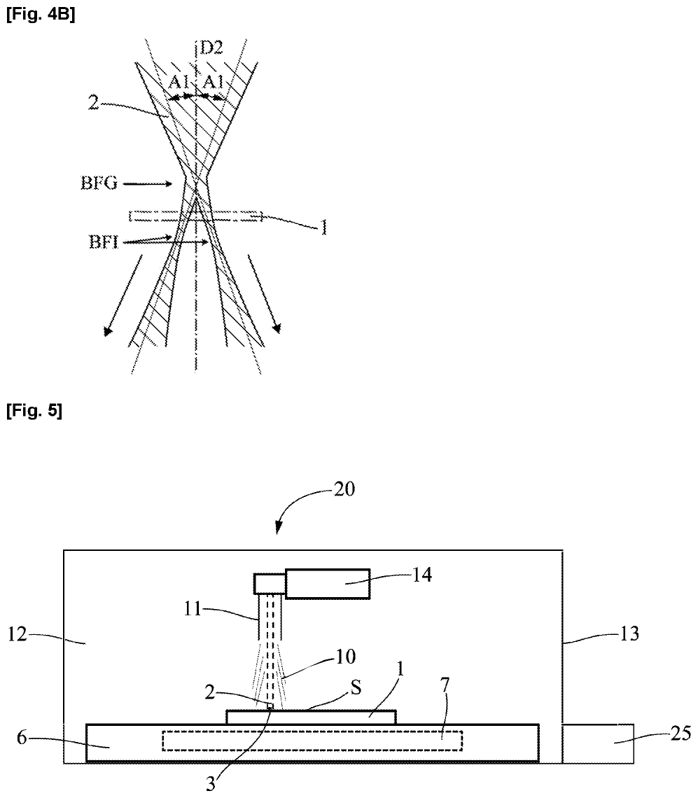

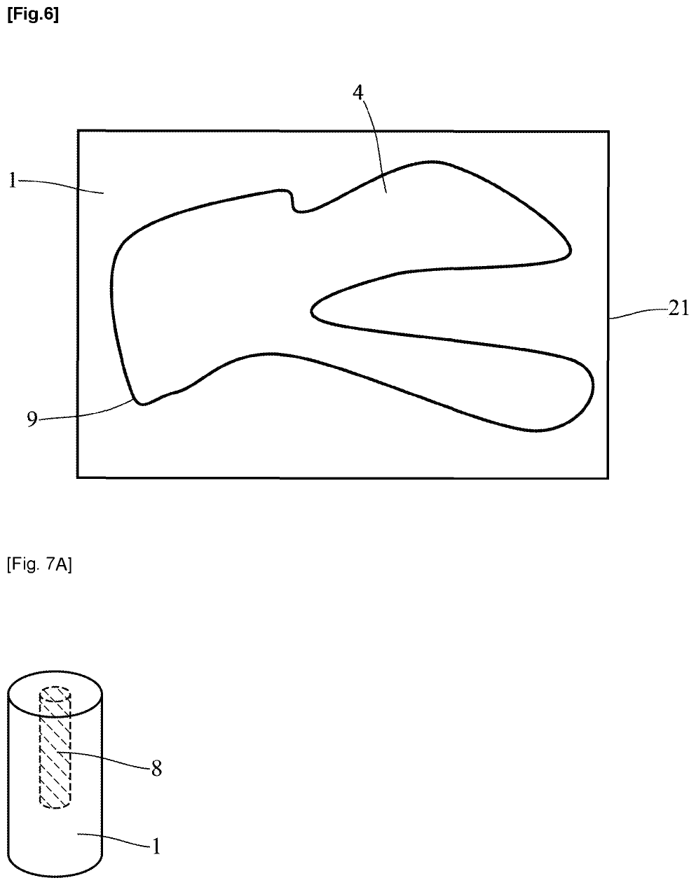

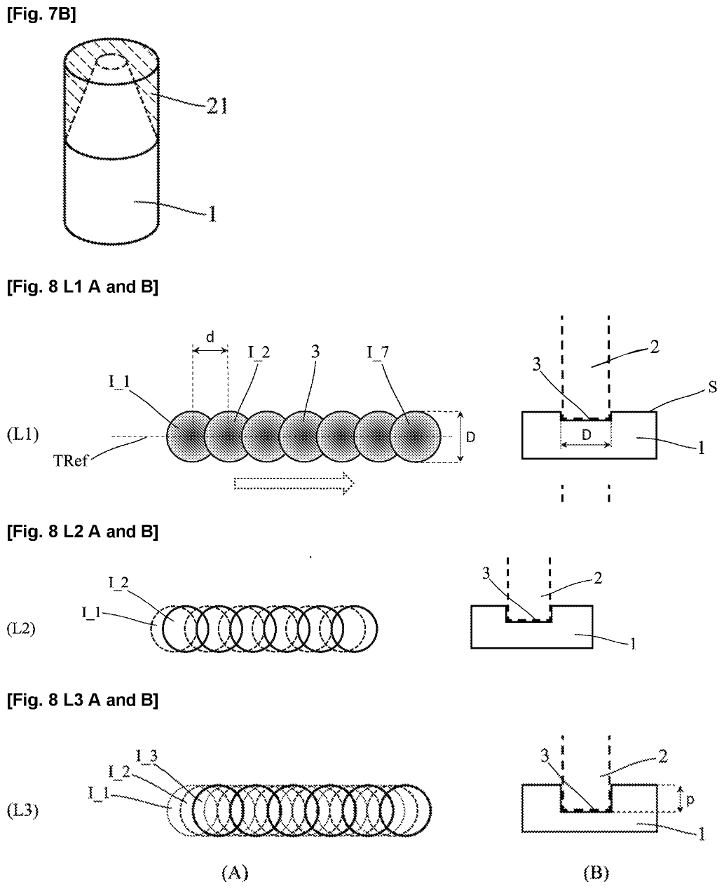

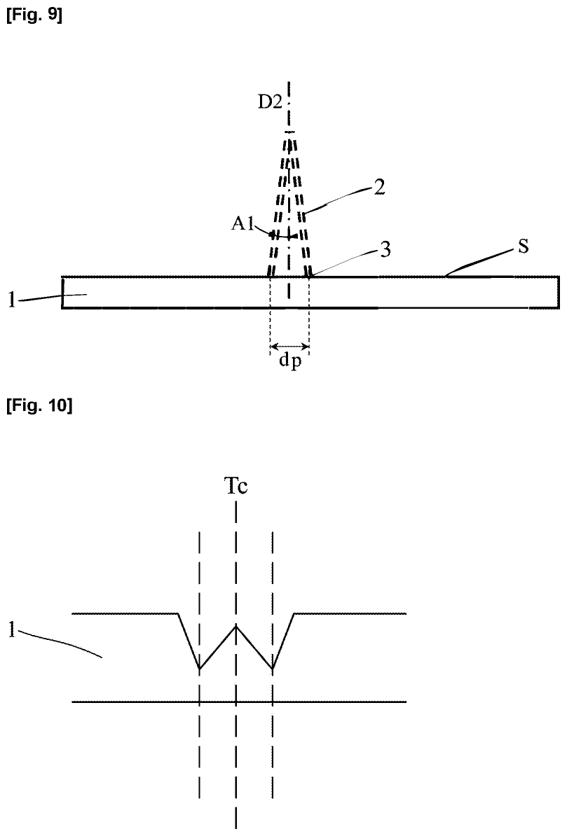

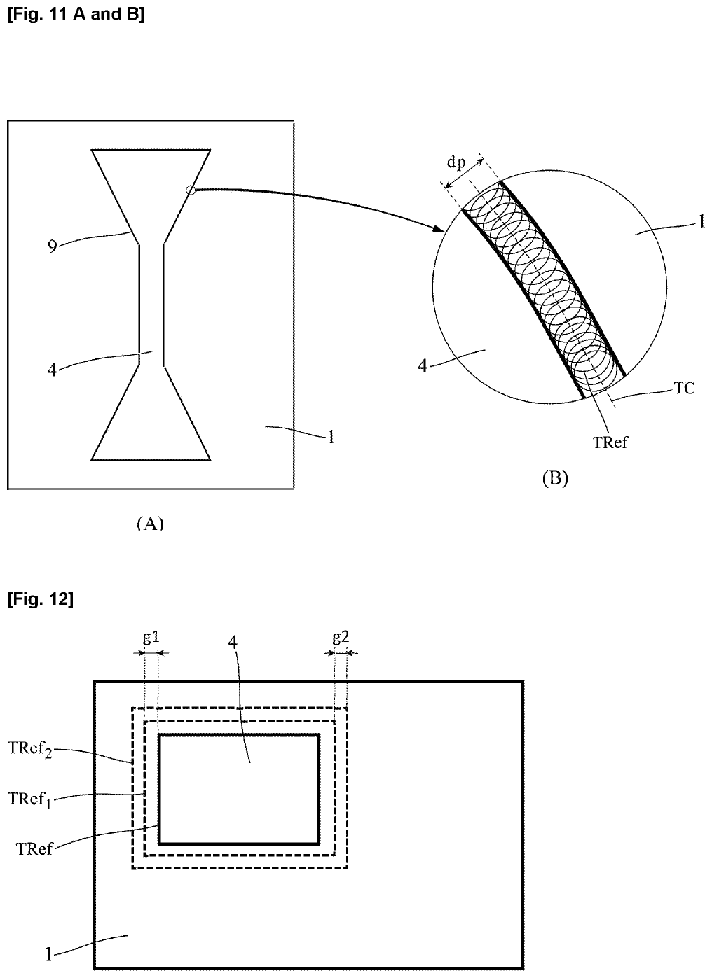

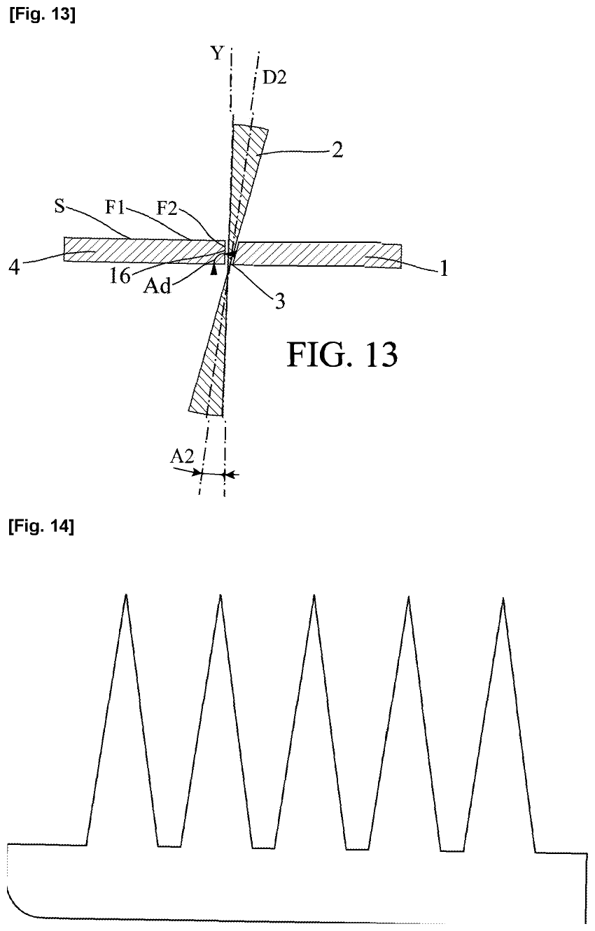

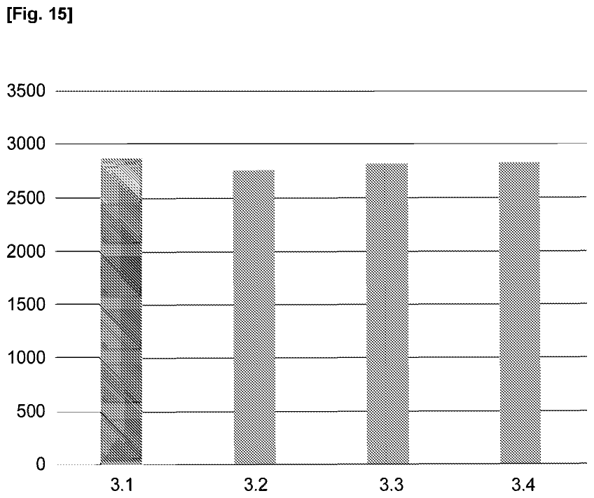

Other characteristics, details and advantages will appear on reading the detailed description below and on analyzing the attached drawings, in which:

[FIG. 1] represents an X-ray diffraction analysis of an amorphous metal alloy,

[FIG. 2] represents an X-ray diffraction analysis of a partially amorphous metal alloy,

[FIG. 3] represents an X-ray diffraction analysis of a crystalline metal alloy,

[FIG. 4] represents a schematic sectional view of a laser beam,

[FIG. 5] is a schematic side view of an installation capable of implementing a method for machining an amorphous metal alloy sample,

[FIG. 6] is a schematic top view illustrating an implementation embodiment of the machining method,

[FIG. 7] is a schematic side view illustrating two implementation modes of the machining method,

[FIG. 8] is a schematic view detailing one embodiment of the machining method,

[FIG. 9] is a schematic side view detailing an optional characteristic of the method,

[FIG. 10] is a schematic sectional view detailing the optional characteristic of FIG. 9,

[FIG. 11] is a top schematic view, detailing the optional characteristic of FIG. 9,

[FIG. 12] is a schematic top view detailing another optional characteristic of the method,

[FIG. 13] is a schematic side view detailing another optional characteristic of the method,

[FIG. 14] is a diagram of the geometry machined in example 1,

[FIG. 15] is a diagram representing the results of the bending tests of the Example 2.

### DESCRIPTION OF EMBODIMENTS

In order to make the figures easier to read, the different elements are not necessarily represented to scale. In these figures, identical elements bear the same references. Certain elements or parameters can be indexed, that is to say designated for example by first element or second element, or even first parameter and second parameter, etc. This indexing aims to differentiate similar, but not identical, elements or parameters. This indexing does not imply a priority of one element, or one parameter, over another and it is possible to interchange the names.

For the purposes of this description, it is appropriate to clarify the following definitions.

The term <<one>> means <<at least one>>.

The term <<amorphous metal alloy>> or <<AMA>> or <<metallic glass>> means metals or metal alloys which are not crystalline, that is to say whose atomic distribution is mainly random. However, it is difficult to obtain 100% amorphous metallic glass because there most often remains a fraction of the material which is crystalline in nature. This definition can therefore be generalized to metals or metal alloys which are partially crystalline and which, therefore, contain a fraction of crystals, as long as the amorphous fraction is in the majority. Generally, the fraction of the amorphous phase is greater than 50%. The term <<amorphous metal alloy>> or <<AMA>> or <<metallic glass>> is therefore understood to mean metals or metal alloys whose fraction of the amorphous phase is greater than 50%, preferably greater than 65%, more preferably greater than 75% and more preferably even greater than 80%.

It is specified here that a metallurgical structure is said to be amorphous or entirely amorphous when an analysis by X-ray diffraction (analysis method which will subsequently be called XRD) as described below does not reveal crystallization peaks.

The term <<critical diameter>> (noted Dc) of a specific metal alloy means the maximum limiting thickness below which the metal alloy presents an entirely amorphous metallurgical structure or beyond which it is no longer possible to obtain a fully amorphous metallurgical structure, when the metal alloy is molded from a liquid state and is subjected to rapid cooling such that heat transfer within the metal alloy is optimal. More specifically, the critical diameter is determined by successive molding of cylindrical bars, generally of a length greater than 50 mm and of different diameters, molded from the liquid state under the following conditions:

The alloy is molten at a temperature of TI+150° C. with TI, the liquidus temperature of the alloy (in ° C.);

The alloy is molded in a CuC1 type copper mold and is cooled to a maximum temperature of about twenty degrees Celsius (20° C.).

The alloy is developed and molded under an inert, high-purity atmosphere (e.g. under argon of quality 6.0) or under secondary vacuum (pressure <10⁴ mbar).

The alloy is molded with a system allowing the application of a pressure differential to facilitate the molding of the alloy and ensure intimate contact between the alloy and the walls of the mold in order to ensure rapid cooling of the alloy. The molding step can be carried out under a pressure of 20 MPa. This overpressure application system can be mechanical (piston) or gaseous (application of overpressure).

After molding, the bars are cut to obtain a slice, that is to say a cross section of the cylinder preferably located towards the middle of the bar, and with a thickness comprised between 1 and 10 millimeters. The obtained slices are analyzed by X-ray diffraction to determine whether the slices have an amorphous or partially crystalline structure. The critical diameter is then determined as the maximum diameter for which the structure is amorphous. The presence of bumps characteristic of amorphous metal alloys is then demonstrated by X-ray diffraction. Given that there are most often defects in metallurgical structures, a 100% amorphous alloy is almost impossible to obtain, and the critical diameter can be defined as the diameter above which an X-ray diffraction analysis clearly highlights crystallinity peaks. Such an evaluation of the amorphous character of a metal alloy is detailed in the article Cheung et al., 2007 (Cheung et al. (2007) <<Thermal and mechanical properties of Cu—Zr—Al bulk metallic glasses>> doi:10.1016fj.jallcom.2006.08.109). It makes it possible to carry out an average analysis on a surface and to overcome the few inevitable metallurgical defects, while only analyzing crystals of significant size, that is to say greater than a few nanometers and/or in significant quantities. FIGS. 1, 2 and 3 represent an XRD analysis as previously described. These figures show the intensity of the diffracted beam as a function of the angle between the incident beam and the diffracted beam. FIG. 1 is an XRD analysis of a metal alloy in an amorphous state. FIG. 2 is a similar analysis carried out on a partially amorphous alloy. In this figure, the characteristic bump of amorphous structures is found, but with the presence of peaks as well. FIG. 3 is a similar analysis carried out on a crystalline alloy. In FIG. 3, the characteristic bump of AMA is not present, and the crystallinity peaks are clearly visible.

The term <<AMA with low thermal stability>> means a metal alloy having:
a critical diameter Dc less than 5 millimeters, preferably less than 3 millimeters, and/or
a difference ΔTx between the crystallization temperature Tx and the glass transition temperature Tg less than 60° C., and/or
a quotient (ΔTx/(TI−Tg)), corresponding to the quotient of the difference ΔTx between the crystallization temperature Tx and the glass transition temperature Tg and the difference between the liquidus temperature TI and the glass transition temperature Tg, less than 0.12, preferably less than 0.1.

The critical diameter Dc, the difference ΔTx=Tx-Tg between the crystallization temperature Tx and the glass transition temperature Tg, as well as the quotient ΔTx/(TI−Tg) are quantities which all three define a thermal stability criterion metal alloy. The lower the value of each of these three quantities, the more unstable the alloy, in other words the more difficult it is to maintain the metal alloy in an amorphous state.

The term <<machining>> means an ablation of material from a sample 1. By ablation of material, is meant a removal of material, the two terms being equivalent. Thus, in the context of the present application, <<ablate>> material and <<remove material are equivalent terms. The machining can be through, as is the case for cutting or drilling. In other words, the laser beam removes material until it passes through the sample. The machining can be non-through, as is the case for engraving, blind drilling, surfacing, for example to obtain a given roughness, or even for the production of surfaces or sides whose angle formed therebetween has excellent precision, for example an angle of 90°±1.5°, preferably 90°±1°, more preferably 90°±0.5°. Non-through machining leaves a thickness of unmachined material.

The term <<microcomponent>> means a component of small dimensions, for example a component of which at least one of the dimensions does not exceed 2 millimeters (mm), or even 1 mm, preferably 200 microns (μm), more preferably 100 μm or even 50 μm. The term <<mechanical microcomponent>> means a microcomponent capable of cooperating with one or more other microcomponents.

The term <<fluence>> of the laser beam means the <<peak fluence>> of the laser beam, the energy delivered per unit area. It is expressed in J/cm².

The term <<diameter D>> or <<spot diameter>> of the laser beam means the diameter of the portion 3 irradiated on the sample 1 by the laser beam 2. In other words, the diameter D is therefore the diameter of the laser beam 2 focused on the sample 1. Indeed, and as illustrated in part A of FIG. 4, in practice the laser beam 2 is of Gaussian shape. In other words, the laser beam 2 is a Gaussian beam.

Consequently, the diameter of the irradiated portion 3 depends on the distance between the emission point of the laser beam 2 and the irradiated portion 3. The diameter D, sometimes called spot diameter, can also be called diameter of the portion 3 irradiated on the sample 1 or even diameter of the laser beam 2 focused on the sample 1.

The term <<focal plane of the individual beam>> (<<Best Focus Individual Beam, also indicated under the acronym <<BFI>> means the plane in which the laser beam 2 is most focused. The part A of FIG. 4 illustrates the notion of BFI. The distance between the irradiated portion 3 of the sample and the BFI impacts the ablation capabilities of the laser beam 2.

The laser beam 2 can be driven by a precession movement. The precession movement of the laser beam 2 is schematized in FIG. 9 and the part B of FIG. 4. In this last figure, a schematic sectional view of two positions of the same laser beam 2 animated by a precession movement is schematized. When machining a part 4, the actual movement of the laser beam 2 thus corresponds to the composition of two movements. As shown in FIG. 11, the first movement is a movement along a setpoint trajectory TC. The second movement is the precession movement. The precession movement therefore makes it possible to change the angle of incidence of the beam throughout the machining method. Thus, when the target trajectory TC is rectilinear, the zone irradiated by the laser beam 2 on the sample 1 to be machined describes a trochoidal trajectory. In other words, the reference trajectory TRef is then a trochoid. The part B of FIG. 11 is an enlargement of a portion of part A. On the principle diagram of part B of FIG. 11, the setpoint trajectory TC appears to be almost rectilinear. When the displacement of the laser beam 2 does not comprise a precession movement, the reference trajectory TRef is merged with the reference trajectory TC. With a precession movement as illustrated in FIG. 11, the reference trajectory TRef describes loops moving along the setpoint trajectory TC.

When the displacement of the laser beam 2 includes a precession movement, the laser beam 2 oscillates around its average direction D2 and describes the shape of a cone with an angle of attack relative to the surface of the sample 1. The angle of incidence of the laser beam 2 therefore changes during the machining method.

The term <<focal plane of the precession ring>> (<<Best Focus Global Beam>>, also indicated under the acronym <<BFG>> means the focal plane where the individual laser beam 2 is defocused and rotates almost on itself during precession. The part B of FIG. 4 illustrates the concept of the best focus global beam (BFG).

By <<focusing altitude>> means with a precession movement the distance between the upper surface of the sample 1 and the focal plane where the individual laser beam 2 is defocused and rotates almost on itself during the precession (BFG).

A laser cutting installation 20 is shown schematically in FIG. 5. The installation comprises an enclosure 13 in which is arranged a laser transmitter 14 capable of emitting a laser beam 2. A sample 1 is placed opposite the point of emission of the laser beam 2. The sample 1 can thus be irradiated by the laser beam 2, that is to say the laser beam 2 can reach part of the surface S of the sample 1 and interact with the material of the sample 1. The portion of the sample 1 irradiated by the laser beam 2 is designated by the reference sign 3. The sample 1 can be fixed on a plate 6 acting as a support.

The interaction between the laser beam 2 and the sample 1 makes it possible to carry out material removal in the irradiated portion 3. This material removal is also called material ablation. A relative displacement of the laser beam 2 with respect to the sample 1 makes it possible to displace the irradiated portion 3 and to carry out an ablation of material along a reference trajectory TRef.

The laser beam 2 can be movable so as to be displaced relative to the sample 1. The sample 1 can then be immobilized relative to the enclosure 13 of the installation 20. An electronic control unit 25 makes it possible to control the triggering and interruption times of the laser beam 2, as well as the displacement movements of the laser beam 2 relative to the sample 1. The reference trajectory TRef can thus be controlled in real time.

Alternatively, the sample 1 to be machined can be movable so as to be displaced relative to the laser beam 2. For this, the sample 1 to be machined is fixed to a movable plate along at least 2 axes.

Alternatively, the laser beam 2 and the sample 1 to be machined can both be movable, successively or concomitantly, in particular to facilitate the machining of complex parts. In all cases, there is a relative movement of the laser beam 2 relative to the sample 1 so as to obtain a displacement of the laser beam 2 along the reference trajectory TRef.

The sample 1 to be machined can have any shape and the portion of sample 1 to be ablated can also be of any shape, in a through manner or not.

As an example, in an embodiment, the sample 1 to be machined is flat. In other words, the sample 1 to be machined is an amorphous metal alloy plate. The thickness of the sample 1 to be machined is preferably comprised between 5 μm and 2 mm, preferably between 10 μm and 1 mm.

In another embodiment, the sample 1 to be machined is a cylinder or comprises a cylindrical part and the method aims to provide an axis, in a through manner or not, within said cylinder or said cylindrical part. The diameter of the microcomponent resulting from the machining method preferably has a diameter, preferably a maximum diameter, less than or equal to 2 mm.

The amorphous metal alloy of the sample 1 to be machined can for example contain in atomic fraction more than 40% of Nickel (Ni), preferably more than 50% of Nickel (Ni).

According to another example of application of the method compatible with the previous mode, the amorphous metal alloy of the sample 1 to be machined contains in atomic fraction more than 50% of the elements Nickel (Ni) and Niobium (Nb), preferably more than 60% of the elements Nickel (Ni) and Niobium (Nb), more preferably more than 70% of the elements Nickel (Ni) and Niobium (Nb).

The alloy with low thermal stability can also be selected from alloys based on Zr, Cu, Ti, Fe or Co. Here is meant <<based on>> the fact that the element cited constitutes the majority element of the alloy.

The alloys with low thermal stability as described above are particularly difficult to shape while retaining their amorphous character. The method described here is therefore particularly advantageous for shaping such alloys.

The present invention proposes a method for machining a sample 1 of amorphous metal alloy using a femtosecond laser, comprising at least one step of irradiating the sample 1 with a laser beam 2 along a reference trajectory TRef to ablate material from the sample 1, in a through manner or not, along the reference trajectory TRef so as to obtain a sample 1 machined and maintained in the amorphous state, in which:
the laser beam 2 is pulsed, and
the duration of each pulse is less than 1000 femtoseconds, preferably less than 600 femtoseconds, more preferably comprised between 100 femtoseconds and 600 femtoseconds, and in which:
the laser beam 2 is movable so as to be displaced relative to the sample 1 to be machined along the reference trajectory TRef, or
the sample 1 to be machined is movable so as to be displaced relative to the laser beam 2 along the reference trajectory TRef.

The amorphous metal alloy of the sample 1 is an alloy with low thermal stability.

According to an embodiment of the method:
the laser beam 2 is movable so as to be displaced relative to the sample 1 to be machined along the reference trajectory TRef; and
the pulsation frequency f of the laser beam 2 is greater than 1 kHz, preferably greater than 20 kHz; and
the scanning speed of the laser beam 2 is less than 2000 mm/s, preferably less than 1000 mm/s and even more preferably less than 600 mm/s.

FIG. 6 illustrates the concept of the sample 1, machined sample 1 and/or part 4. The sample 1 forms the raw material or preform to be machined. After one or more machining operations, a machined sample 1 or a part 4, also called a microcomponent, is obtained. The part 4 can be a detached part of the sample 1, in particular when the method is a cutting method, also called through machining. The sign 9 schematizes the perimeter 9 of the part 4. The shape of the part 4 can be any. In the example of FIG. 6, the part 4 is entirely included within the perimeter 21 of the sample 1. According to an example not shown, a part of the perimeter 21 of the sample 1 can be portion of the part 4.

The relative trajectory TRef can define part of the periphery 9 of the part 4. In other words, the machining method can be implemented in order to form only part of the periphery 9 of the part 4. The rest of the periphery 9 of the part 4 can be obtained by other methods or transformation methods. A part of the periphery 9 of the microcomponent 4 can also be formed by a portion of the periphery 21 of the sample 1, which then remains raw in this area.

According to an alternative embodiment compatible with the previous mode, the machined sample or part 4 can be the sample 1 from which a part of the initial material has been ablated without the ablation of material being through. The concept of non-through ablation is illustrated in particular in FIG. 8.

As an example illustrated in the part A of FIG. 7, the sample 1 can be a cylinder and the portion to be ablated 8 can be such that it allows a bearing to be machined in the part 4. It can be for example a bore, in a through manner or not, within the part 4, which can cooperate with an axis.

According to an alternative embodiment compatible with the previous modes and illustrated in the part B of FIG. 7, the machining method can make it possible to machine a pivot, for example of conical shape, terminating a cylindrical portion, in particular an axe. The ablated area is shown in dotted lines in FIG. 7 and bears the reference 21.

By pulsed laser is meant the fact that the laser beam 2 is applied in successive pulses. In other words, a pulse of laser beam 2 is applied for a duration t1, then the application of the laser beam is stopped for another duration t2. The frequency f at which the pulses are applied is called pulsation frequency or repetition rate of the laser beam 2. This frequency f is equal to the inverse of the period T, which is the sum of the durations t1 and t2.

FIG. 8 illustrates the application of successive pulses of the laser beam 2. The column A of FIG. 8 is a top view of the sample 1. The column B is the corresponding side view. Each pulse of the laser beam 2 irradiates a portion 3 of the sample 1 to be machined, and the portion 3 irradiated by a pulse I_n covers at least partially the portion 3 irradiated by the previous pulse I_n−1.

In FIG. 8, the successive pulses are applied from left to right. The sign I_1 schematizes the portion irradiated by the first applied pulse. I_2 schematizes the portion irradiated by the second applied pulse. I_7, which schematizes the portion irradiated by the seventh applied pulse, is the last represented pulse. The impulses can of course continue.

Two successive pulses are applied with a spatial offset d. The offset d between two portions irradiated by two successive pulses I_n−1, I_n of the laser beam 2 is preferably such that there is at least partial overlap for two successive irradiated portions I_n−1, I_n. According to one embodiment, each pulse of the laser beam 2 irradiates a portion 3 of the sample 1 to be machined on the reference trajectory Tref, the portion 3 irradiated by a pulse I_n at least partially covers the portion 3 irradiated by the previous pulse I_n−1, and the overlap between two portions 3 irradiated by two successive pulses I_n−1, I_n of the laser beam 2 is at least 25% of the surface of the diameter D of a portion 3 irradiated by the laser beam 2 and at most 95% of the surface of the diameter D of a portion 3 irradiated by the laser beam 2.

In other words, the portion irradiated 3 by a pulse I_n of the laser beam 2 is here offset relative to the portion irradiated 3 by the previous pulse I_n−1 by a distance d less than the diameter D of the laser beam 2. For reasons of clarity, the offset between successive pulses has been exaggerated in FIG. 8. The diameter D of an irradiated portion 3 corresponds to the spot diameter of the laser beam 2.

The spot diameter D of the laser beam 2 or diameter D of the laser beam projected onto the portion 3 of the sample 1, is preferably less than 100 μm, preferably comprised between 5 and 100 μm, preferably 10 to 60 μm, more preferably 10 to 30 μm.

The pulsation frequency f of the laser beam 2 is preferably greater than 1 kHz. Preferably, the pulsation frequency f of the laser beam 2 is greater than 20 kHz. More preferably, the pulsation frequency f of the laser beam 2 is comprised between 20 kHz and 400 kHz, preferably between 20 kHz and 300 kHz.

The laser beam 2 may be an infrared laser beam, in particular an infrared laser beam having a wavelength comprised between 800 nm and 1100 nm, in particular a wavelength of 1030 nm±5 nm.

The laser beam 2 can also be a green laser beam, in particular a green laser beam having a wavelength comprised between 500 nm and 540 nm, in particular a wavelength of 515 nm±5 nm.

The laser beam 2 can also be an ultraviolet laser beam, in particular an ultraviolet laser beam having a wavelength of less than 400 nm, in particular a wavelength of 343 nm±25 nm.

The laser beam 2 can also be a blue laser beam, in particular a blue laser beam having a wavelength comprised between 400 nm and 480 nm.

The absorption rate of the material of the sample 1 is a function of the wavelength/material pair of said sample 1. For certain materials, for example the metals, the wavelengths in the green generally have a better absorption rate, which promotes the ablation of the material. However, the lower the wavelength, the more expensive the method will be.

According to an advantageous embodiment, the laser beam 2 has a peak fluence greater than 15 J/cm2, preferably greater than 20 J/cm2, from 40 J/cm2 to 400 J/cm2.

The fluence is the energy level required per unit surface to ablate the material, that is to say remove material in the area irradiated by the laser beam. It depends on the energy and diameter of the laser beam. For example, for a Gaussian beam, the fluence is calculated using the following formula:

$$F = 2 \times \frac{E}{π {r}^{2}} \qquad [ MATH 1 ]$$

with:
r: the radius of the laser beam at the level of the irradiated portion of the sample
E: the laser energy
F: the fluence, expressed in J/cm²

The fluence is calculated in the initial configuration, that is to say from the diameter D of the beam at time t0 of the machining method.

There are other types of laser beam, for which the fluence calculation is different.

According to one embodiment, the laser beam 2 has an average power greater than 0.4 W, preferably greater than 1.5 W, more preferably from 1.5 W to 30 W.

The power (in watt W) is the product of the energy (in joule J) and the frequency of the laser (in s⁻¹). For a Ni-based AMA sample 1, the selected power of the laser beam 2 is preferably comprised between 0.425 W and 20 W.

According to an advantageous embodiment, the laser beam 2 is displaced along the reference trajectory TRef at a scanning speed less than 2000 mm/s. Preferably, the scanning speed is less than 1000 mm/s, and even more preferably is less than 600 mm/s.

According to an embodiment, the step of irradiating the sample 1 with a laser beam 2 along a relative reference trajectory TRef is iterated at least once, preferably at least 100 times, more preferably at least 300 times. The number of iterations is adapted according to the quantity of material to be ablated. The relative reference trajectory TRef during an iteration R_p is merged with the relative reference trajectory Tref of the previous iteration R_p−1. The line L1 in FIG. 8 schematizes the first passage of the laser beam 2. The line L2 schematizes the second passage of the laser beam 2, that is to say the iteration of higher rank compared to the previous iteration. The line L3 schematizes the third passage, again the iteration of higher rank compared to the previous iteration. The solid circles describe the portions irradiated during the current iteration and the dotted circles describe the portions irradiated during a previous iteration. In other words, the laser beam 2 can always scan the same trajectory until obtaining the ablation of material corresponding to the desired thickness of remaining material. The remaining material thickness is zero when the machining is through. In FIG. 8, the depth p of the zone where the material has been ablated gradually increases, as the passage of the laser beam 2 is repeated along the relative reference trajectory TRef.

According to an optional implementation mode of the machining method, the displacement of the laser beam 2 comprises a precession movement. The precession movement makes it easier to obtain straight-sided machining.

As shown schematically in FIG. 9, the precession angle A1 of the laser beam 2 is preferably less than 10°, preferably less than 8°. The precession movement of the laser beam 2 delimits a zone of width dp. The precession angle A1 corresponds to the angle between the average direction D2 of the laser beam 2 and the instantaneous direction Di of the laser beam 2 during the precession.

Advantageously, the precession speed of the laser beam 2 is comprised between 500 rpm and 40,000 rpm.

As illustrated in FIG. 10, the ablation of material carried out by the laser beam 2 to which a precession movement is applied can have substantially a W shape thus making it possible to limit the concentration of energy in a precise zone of the sample 1 to be machined.

According to an alternative embodiment which is particularly advantageous for obtaining perpendicular sides 16, in particular sides 16 such that between them they form an angle Ad of 90°±1.5°, preferably 90°±1°, more preferably 90°±0.5°, the average direction D2 of the laser beam 2 forms an angle A2 with the direction normal to the surface of the portion 3 irradiated by said laser beam 2 comprised between 80° and 90°, preferably comprised between 82° and 90°. This embodiment is illustrated in FIG. 13. In other words, an angle A2 between the average direction D2 of the laser beam 2 and the direction normal to the surface of the irradiated portion 3 of the sample 1 is less than 10°, preferably less than 8°.

The laser beam 2 is thus inclined relative to the direction Y normal to the surface of the irradiated portion 3 of the sample 1. This angle of inclination A2 makes it possible to improve the perpendicularity of the sides 16 of the machined part 4.

Indeed, the angle of inclination A2 makes it possible to compensate for the perpendicularity defects linked to the fact that the laser beam 2 is Gaussian.

Advantageously, and in particular in association with the previous embodiment, the laser beam 2 can have a variable focusing altitude. The altitude of the best focus global beam (BFG) can be movable and move down towards the sample as the machining progresses; and/or the altitude of the best focus individual beam (BFI) can be displaced towards the sample 1 or within said sample 1 as the machining progresses;
the focusing altitude at the start of the machining being comprised between the altitude of the best focus global beam (BFG) and the altitude of the best focus individual beam (BFI).

Indeed, when the focusing altitude is fixed, the diameter D of the irradiated portion depends on the thickness of material already removed by the laser beam 2. This embodiment is therefore particularly advantageous for maintaining a diameter D irradiated constant over at least part of the machining method, as the machining progresses and the material is ablated. This embodiment makes it possible in particular to improve the cycle time of the machining method.

According to an embodiment compatible with the previous modes, the machining of the sample 1 can be carried out by a strategy of successive cuts which converge towards the final shape desired for the part 4. Thus, the first made cut(s) are one or more outlines. The last made cut gives the part the desired geometry in the area treated by the laser beam.

For this, the machining method is carried out by the implementation of at least one outline according to at least one trajectory TRef+n, n being the total number of implemented outlines. This embodiment is illustrated in FIG. 12. In this figure, three outlines have been produced. The first outline is made along the reference trajectory TRef2. The second outline, represented schematically by a second reference trajectory TRef1, is offset by a distance g2 relative to the first outline. The third outline, schematized by a third reference trajectory, corresponding to the final machining reference trajectory of part 4, namely the reference trajectory TRef. The trajectory TRef is offset by a distance g1 relative to the second outline.

Thus, according to the previous embodiment, the method comprises:
optionally at least one step of irradiating (c) the sample 1 with a laser beam 2 along a reference trajectory TRef+n to ablate the material from the sample 1, in a through manner or not, along the reference trajectory TRef+n,
a step of irradiating (b) the sample 1 with a laser beam 2 along a reference trajectory TRef+1 to ablate the material from the sample 1, in a through manner or not, along the reference trajectory TRef+1,
a step of irradiating (a) the sample 1 with a laser beam 2 along a reference trajectory TRef to ablate the material from the sample 1, in a through manner or not, along the reference trajectory TRef,
the reference trajectory TRef+1 being adjacent to the reference trajectory TRef and translated by a given distance g1 from said reference trajectory TRef; and
optionally, the reference trajectory TRef+n is adjacent to the reference trajectory TRef+(n−1) and translated by a given distance g2 from said reference trajectory TRef+n−1 in the direction opposite to that of the trajectory TRef.

The given distances g1, g2, gn between two directly adjacent reference trajectories TRef; TRef+1, TRef+(n−1); TRef+n are such that the pulses of the laser beam 2, irradiating the sample 1 to be machined on the first reference trajectory TRef; TRef+1, TRef+(n−1) or TRef+n, also irradiates, at least partially, the sample 1 to be machined on the reference trajectory(s) TRef; TRef+1, TRef+(n−1) or TRef+n which is or are directly adjacent to it. The distances g1, g2, gn can be the same or different.

The steps (a) and/or (b) and/or, optionally (c) can be repeated, preferably successively, until obtaining a part 4 machined according to the desired final geometry, and maintained in an amorphous state.

The implementation of one or more outlines as described above makes it possible in particular to limit the risks of crystallization of the sample 1 into an amorphous alloy. It also makes it possible to improve the surface condition of the cut sides.

The machining method using the laser beam 2 can, optionally, be coupled with the presence of a gas flow on the sample 1 to be machined. The machining method can thus include the step of:
sending a flow of gas 10 to the sample 1 to be machined.

The gas flow 10 is then maintained during all or part of the machining method.

For this, a blowing nozzle 11, shown schematically in FIG. 5, guides the flow of gas 10 towards the sample 1. The flow of gas 10, sent to the sample 1 to be cut, makes it possible to cool the sample 1 and contributes to avoiding excessive heating of said sample 1. The gas flow 10 also makes it possible to evacuate the particles coming from the ablation of material by the laser beam 2. For example, the gas flow 10 sent to the sample 1 to be machined is an air flow. The gas flow 10 sent to the sample 1 to be machined can also be an inert gas flow. In the example shown schematically in FIG. 5, the gas flow 10 sent to the sample 1 is blown in a direction coaxial with the direction of the laser beam. The gas flow may also not be coaxial with the direction of the beam.

Also optionally, the sample 1 to be machined can be protected from the oxidation during the cutting operation. For this, the cutting method can include the step of:
placing the sample 1 to be machined by the laser beam 2 in a medium 12 protecting from the oxidation.

The enclosure 13 in which the sample 1 and the laser beam 2 are advantageously contained can thus contain a protective medium 12. According to an example of implementation, the protective medium 12 of the oxidation is a gas whose pressure is lower than atmospheric pressure. According to a variant, the protective medium 12 for oxidation is an inert gas.

In addition and concomitantly, the method may include the step of:
sucking the gases in the vicinity of the irradiated portion of the sample 1.

The suction of the gases in the vicinity of the irradiated portion 3 of the sample 1 makes it possible to promote the evacuation of the metal particles detached from the sample 1 by the effect of the laser beam 2. In FIG. 5, the gas suction system has not been shown.

Still optionally, the sample 1 can be cooled during the cutting operation.

Thus, and as illustrated in FIG. 5, the sample 1 to be machined is thermally coupled to a plate 6 comprising a cooling system 7 configured to absorb heat from the sample 1 to be machined. The sample 1 to be machined can be fixed to the plate 6. The cooling system 7 also helps to avoid excessive temperature rise of the sample 1 during the machining method.

The cooling system 7 may comprise a Peltier effect module configured to exchange heat with the plate 6. Alternatively or in a complementary manner, the cooling system 7 may comprise a heat transfer fluid circuit configured to exchange heat with the plate 6. Other means of cooling are also possible.

The sample 1 can also be completely or partially immersed in a heat transfer liquid. The heat transfer liquid can be static or in motion (flow).

The invention also concerns a method for producing a surface of a sample 1 in an amorphous metal alloy with low thermal stability using a femtosecond laser. Said method comprises at least one step of irradiating with a laser beam 2 a first surface of the sample 1 so as to obtain a second surface whose roughness Ra is less than 400 nm, preferably less than 200 nm, more preferably less than 100 nm. In such a method, the laser beam 2 is pulsed and the duration of each pulse is less than 1000 femtoseconds, preferably less than 600 femtoseconds, more preferably between 100 femtoseconds and 600 femtoseconds.

The embodiments of the machining method described above are also applied to said method for producing a surface of a sample 1 of an AMA.

The invention also concerns a method for cutting a sample 1 of an amorphous metal alloy with low thermal stability using a femtosecond laser.

In this cutting method, the method comprises at least one step of irradiating with a laser beam 2 a first surface of the sample 1 on a face F1 so as to obtain a second face F2 such that in each point of intersection of the faces F1 and F2, said faces F1 and F2 form therebetween an angle Ad of 90°±1.5°, preferably 90°±1°, more preferably 90°±0.5°. The laser beam 2 is pulsed, and the duration of each pulse is less than 1000 femtoseconds, preferably less than 600 femtoseconds, more preferably between 100 femtoseconds and 600 femtoseconds.

The embodiments of the machining method described above are also applied to said method for cutting a sample 1 of an AMA.

The methods described above thus make it possible to obtain AMA parts with very precise dimensions and an excellent surface finish, while retaining the amorphous state of the alloy. In addition, the operating parameters of said methods allow industrial type production, because the cycle time to obtain a part is sufficiently low.

The invention also relates to a method for manufacturing an amorphous metal alloy part 4. The manufacturing method includes the steps of:
melting a mixture of metals to obtain a piece of alloy,
injecting the piece obtained into a mold and cooling the molded alloy with a cooling speed greater than a critical speed of crystallization of the alloy, to obtain a sample 1 of amorphous alloy,
machining at least one surface of the sample 1 according to the machining method described previously or according to the method for producing a surface described previously or according to the cutting method previously described to obtain a part 4 in amorphous alloy according to a predetermined geometry.

Optionally, the manufacturing method comprises the step of:
carrying out a finishing step on at least the machined surface of the sample 1, preferably a tribofinishing step.

The invention finally concerns a microcomponent, in particular a mechanical microcomponent of an AMA including at least one surface 8 machined according to at least one of the preceding methods.

The AMA microcomponent advantageously has an elastic deformation capacity of at least 1.2%, preferably at least 1.5%.

The micromechanical component can for example be an element of a clock mechanism for a mechanical watch, such as a date finger, a toothed wheel, or even an axis. The combination of the intrinsic mechanical properties of amorphous alloys and the precision of the cutting achieved by the method makes it possible to provide micromechanical components particularly suited to this application. It can also be a microcomponent for the medical field, such as an implant.

### LIST OF REFERENCE SIGNS

1: Sample to be machined
2: Laser beam 2
3: Portion 3
4: Workpiece
6: Plate
7: Cooling system
8: Portion to be ablated
9: Perimeter of the part
10: Gas flow
11: Blowing nozzle
12: Protective environment against oxidation
13: Enclosure
14: Laser transmitter
16: Sides
20: Laser cutting installation
21: Perimeter of the sample 1
25: Electronic control unit 25

### EXAMPLES

### Example 1—Conservation of the Amorphous Structure

Alloy samples of formula Ni(57-67)Nb(28-38)Zr(0-10) (atomic percentages) were cut with different sets of parameters detailed in table 1 to validate the maintenance of the amorphous structure of the alloy of the machined samples according to the method of the invention. The Ni(57-67)Nb(28-38)Zr(0-10) (atomic percentages) alloy has low thermal stability within the meaning of the invention. In fact, its critical diameter Dc is only 3 mm, its stability coefficient, that is to say its quotient (ΔTx/(TI−Tg)) of 0.07 and its ΔTx is equal to 40.

The samples were cut from 500 μm thick preforms and a pyramidal shape was selected to study the influence of the cutting width on the thermal allocation of the material.

FIG. 14 represents a diagram of the machined geometry.

Table 1 below summarizes the range of tested parameters. Three sets of settings were tested.

TABLE 1

| Parameters | Set 1 | Set 2 | Set 3 |
|---|---|---|---|
| Pulsed laser | Wavelength 515 nm | | |
| Pulse duration | 230 femtoseconds | | |
| Peak fluence (μJ) | 19 | 38 | 77 |
| Power (W) | 0.425 | 3.4 | 6.8 |
| Frequency (kHz) | 25 | 50 | 100 |
| Scan speed (mm/s) | 50 | 100 | 200 |
| Number of outlines | 3 | 3 | 3 |

Table 2 below summarizes the structural state of the samples after cutting.

TABLE 2

| Parameters | Set 1 | Set 2 | Set 3 |
|---|---|---|---|
| Vulkalloys ® | Amorphous | Amorphous | Amorphous |
| Nickel base | | | |

The microstructural analyzes as well as the X-ray diffraction analyzes showed conservation of the amorphous microstructure for all the tested sets, even for the finest areas of the sample, which are the pointed areas.

The surface conditions and roughness of the sides after cutting are also in accordance with the requirement levels necessary for the manufacture of parts in the targeted applications, for which the roughness Ra is less than 0.4.

### Example 2—Maintaining Mechanical Performance

It should be noted here that the properties of amorphous metal alloys are linked to their microstructure. Thus, a modification of the atomic arrangement due to the thermal effect of the laser beam would modify the mechanical properties of the material.

Bars of 200 μm wide made of Ni(57-67)Nb(28-38)Zr(0-10) (atomic percentage) alloy, whose characteristics are detailed in Table 3, were machined by cutting laser and by micro-chainsaw with the aim of quantifying this time the influence of the laser for this type of thickness through mechanical tests. The cutting by micro-chainsaw is a controlled cutting method which does not affect the material, but does not make it possible to obtain optimal surface conditions and perpendicularity of the sides nor to produce complex and precise microcomponent geometries.

The laser parameters used for these samples are presented below:
Pulsed laser
Period 230 femtoseconds
Wavelength 515 nm
Peak fluence 77 J/cm2
Power 6.8 W
Scan speed 100 mm/s
Number of outlines=3

3-point bending tests were carried out on the machined samples.

The bending machine used is an MTS with a 1 kN force cell in compression mode. The test parameters are as follows:
Length between supports L0=5 mm
Crosshead speed v=0.005 mm/s
Total sample length 1=15 mm
Sample width L=500 μm
Sample thickness e=200 μm

The dimensions of the samples are presented in Table 3 below.

TABLE 3

| | Width b | Height h | |
|---|---|---|---|
| Sample | (mm) | (mm) | L0/b |
| Bar no. 1 after laser cutting (3.1) | 0.2 | 0.53 | 27 |
| Bar no. 2 after laser cutting (3.2) | 0.2 | 0.53 | 27 |
| Bar no. 3 after laser cutting (3.3) | 0.2 | 0.53 | 27 |
| Bar No. 4 after molding/after | 0.2 | 0.53 | 27 |
| micro-sawing (3.4) | | | |

FIG. 15 represents the value of the elastic limit in bending, expressed in MPa, for the four samples in table 3. The sample noted 3.4 did not undergo laser machining and serves as a representative control of the properties in the amorphous state. By comparison, it is observed a conservation of the properties of the AMA before and after laser machining for all the samples tested in bending. There is no dispersion in the results and the bending elastic limit value is indeed equal to that obtained for the micro-chainsawed sample. Likewise, it is observed a conservation of properties in the plastic zone.

The values of elastic limit and plastic deformation are also consistent with the values observed on directly molded parts and for which no machining step or other treatment has been carried out.

The developed machining strategy therefore prevents excessive heat input which could modify the microstructure of the material and consequently its properties. The cut parts are therefore not thermally affected, which allows the material to retain its mechanical properties.

The properties of the parts after machining are therefore identical to those of the material obtained after molding. No degradation of mechanical properties is observed.

### Example 3—Obtaining the Desired (Dimensional and Geometric) Quality and Influence on the Rates

The surface condition after machining is an essential property for many microcomponents. Indeed, for the targeted type of application, for example watch movement parts, a low Ra and good perpendicularity of the sides are essential to control tribological contacts and obtain coefficients of friction and low wear rates, which allow to optimize the efficiency of mechanical systems (energy conservation) and their lifespan.

The important quality criteria include the roughness of the machined surfaces, obtaining straight sides, that is to say the perpendicularity between the machined side and the adjacent sides, as well as obtaining non-oxidized parts and without redeposition of particles (burrs).

The quality analyzes were therefore carried out according to the criteria detailed in Table 4 below:

TABLE 4

| | | | Level 3 |
|---|---|---|---|
| Quality | Level 1 | Level 2 | (Non- |
| criterion | (Compliant) | (Acceptable) | compliant) |
| Taper | <0.5° | Between 0.5° | >1° |
| | | and 1° | |
| Roughness | <N5 | =N5 | >N5 |
| Surface | No | Little | Redeposition |
| quality | redeposition | redeposition | of particles |
| (qualitative | of particles | of particles | OR |
| analysis) | AND no | AND little | excessive |
| | oxidation | oxidation | oxidation |

Table 5 below summarizes the results for sets of parameters (machining under air, without nozzle) of preforms, made of AMA such as example 1, machined by a pulsed laser beam of 320 fs and having a wavelength of 532 nm:
Set 1: Low power during the machining
Set 2, 3 and 4: Increase in machining parameters (power, peak fluence, etc.)

TABLE 5

| Parameter sets | Set 1 | Set 2 | Set 3 | Set 4 |
|---|---|---|---|---|
| Power | 0.4 W | 3.4 W | 6.8 W | 7.2 W |
| Pulse frequency | 25 kHz | 50 KHz | 100 KHz | 100 KHz |
| kHz | | | | |
| Scan speed | 100 mm/s | 100 mm/s | 100 mm/s | 200 mm/s |
| Machining time | 62 mins | 8 mins | 4 mins | 2 min |
| Number of | 3 | 3 | 3 | 3 |
| outlines | | | | |
| Taper | Level 1 | Level 1 | Level 1 | Level 2 |
| Roughness | Level 1 | Level 1 | Level 1 | Level 1 |
| Surface quality | Level 1 | Level 1 | Level 1 | Level 2 |
| (qualitative | | | | |
| analysis) | | | | |

The machining of preforms from sets no. 1 and 2 makes it possible to obtain results in accordance with the specifications defined for the machining of microcomponents.

However, for the set no. 1, it took a machining time more than 7 times longer than the parameter set no. 2. The used low power levels made it possible to obtain good surface finishes and low roughness, as well as to maintain the amorphous state, but the machining time necessary to obtain these results is not part of an industrial development approach of a viable cutting solution.

For the sets no. 2 and 3, the microscopic analysis of the post-machining parts reveals a homogeneous surface and surface conditions characteristic of successful laser machining. Indeed, it is observed a diffraction of the light at the sides which is explained by the passage of the laser which creates a <<striated>> surface state. The gap between each streak is sub-micrometric, characteristic of the wavelength of the used laser. The small width between each streak is responsible for the diffraction of light while the regular gap is responsible for the interference phenomenon which creates the colored effect that it can be observed.

In a logic of economic optimization and in order to increase the machining rates, the scanning speed was multiplied by 2 on the set no. 4.

To increase the range of possible parameters and avoid a degradation of quality for ranges close to set no. 4 described above, means allowing better thermal control must be used. In this case, a nozzle projecting gas (air) onto the cutting area was used.

Table 6 below summarizes the results obtained using an air nozzle:

TABLE 6

| Parameter | | |
|---|---|---|
| sets | Set 4 | Set 4 bis |
| Nozzle | No | Yes |
| Power | 7.2 W | 7.2 W |
| Taper | Level 2 | Level 1 |
| Roughness | Level 1 | Level 1 |
| Surface | Level 2 | Level 1 |
| quality | | |

This example illustrates the thermal effect on the machining. The air supply evacuates any projections of ablated material as well as the calories linked to the laser machining which are responsible for the degradation of surface conditions (oxidized surface) and tapers greater than 1° even for a higher number of repetitions.

The material can therefore be machined with greater powers, which makes it possible, from an economic point of view, to increase cutting rates.

### Example 4—Optimization of Cutting Rates

Conventionally, during the laser machining, the focusing altitude is fixed at the start of machining. It is the latter which makes it possible to define the theoretical spot diameter at the start of machining as well as the fluence. In reality, the focusing altitude remains fixed during machining. The method becomes less effective as the cutting depth increases, that is to say as we move away from the ideal focus point for ablating the material.

A so-called <<top-down>> strategy was used to machine the material not with a static focus point on the irradiated surface, but with a focus point on the moving in the direction of the sample (1) during the machining.

Table 7 below summarizes the results obtained during a machining of AMA samples according to example 1 machined with a static focus point (Set 2) or a movable focus altitude (Set 2—<<Top-Down>>).

TABLE 7

| Settings | Set 2 | Set 2—«Top-Down» |
|---|---|---|
| Number of repetitions | 1060 | 760 |
| Taper | Level 1 | Level 1 |
| Roughness | Level 1 | Level 1 |
| Surface quality | Level 1 | Level 1 |

The results show a gain of about 30% with the use of this new strategy. In fact, for equivalent surface qualities, 300 fewer passes will have been necessary to machine the part with the <<top-down>> method.

The use of such a strategy in an industrialization logic makes it possible to significantly increase cutting rates while maintaining the material and dimensional characteristics essential for the machining of microcomponents.

1. A method for machining a sample of amorphous metal alloy using a femtosecond laser, comprising at least one step of irradiating the sample with a laser beam along a reference trajectory to ablate material from the sample, in a through manner or not, along the reference trajectory so as to obtain a sample machined and maintained in an amorphous state,
in which:
the laser beam is pulsed, and
the duration of each pulse is less than 1000 femtoseconds, and
in which:
the laser beam is movable so as to be displaced relative to the sample to be machined along the reference trajectory, or
the sample to be machined is movable so as to be displaced relative to the laser beam along the reference trajectory, and
the pulsation frequency of the laser beam is greater than 20 kHz; and
in which:
the amorphous metal alloy has:
a critical diameter less than 5 millimeters, and/or
a difference between the crystallization temperature and the glass transition temperature less than 60° C., and/or
a quotient of the difference between the crystallization temperature and the glass transition temperature and of the difference between the liquidus temperature and the temperature glass transition less than 0.12.

2. The method according to claim 1, wherein:
the laser beam is movable so as to be displaced relative to the sample to be machined along the reference trajectory; and
the scanning speed of the laser beam is less than 2000 mm/s.

3. The method according to claim 1, wherein the laser beam is:
an infrared laser beam, or
a green laser beam, or
an ultraviolet laser beam, or
a blue laser beam.

4. The method according to claim 1, wherein the laser beam has a fluence greater than 15 J/cm2.

5. The method according to claim 1, wherein each pulse of the laser beam irradiates a portion of the sample to be machined on the reference trajectory, the portion irradiated by a pulse at least partially covers the portion irradiated by the previous pulse, and the overlap between two portions irradiated by two successive pulses of the laser beam is at least 25% of the surface of the diameter of a portion irradiated by the laser beam and at most 95% of the surface of the diameter of a portion irradiated by the laser beam.

6. The method according to claim 1, wherein the step of irradiating the sample with a laser beam along the reference trajectory is iterated at least 1 time, the reference trajectory during an iteration being merged with the reference trajectory of the previous iteration.

7. The method according to claim 1, wherein each pulse of the laser beam irradiates a portion of the sample to be machined on the reference trajectory, and wherein the laser beam has a diameter projected onto the irradiated portion of the sample less than 100 μm.

8. The method according to claim 1, wherein the laser beam has an average power greater than 0.4 W.

9. The method according to claim 1, wherein the displacement of the laser beam comprises a precession movement, and wherein a precession angle of the laser beam is less than 10°.

10. The method according to claim 1, wherein an angle between the average direction of the laser beam and the direction normal to the surface of the irradiated portion of the sample is less than 10°.

11. The method according to claim 9, wherein:
the laser beam has a variable focusing altitude, wherein the altitude of the best focus global beam is movable and is displaced in the direction of the sample progressively as the machining progresses; and or
the altitude of the best focus individual beam is displaced towards the sample or within the sample as the machining progresses;
and the focusing altitude at the start of the machining is comprised between the best focus global beam and the best focus individual beam.

12. The method according to claim 1, wherein the machining method is carried out by the implementation of at least one outline according to at least one trajectory, n being the total implemented number of outlines, the method thus comprising:
optionally at least one step of irradiating the sample with a laser beam along a reference trajectory to ablate material from the sample sample, in a through manner or not, along the reference trajectory,
a step of irradiating the sample with a laser beam along a reference trajectory to ablate material from the sample, in a through manner or not, along the reference trajectory,
a step of irradiating the sample with a laser beam along a reference trajectory to ablate material from the sample, in a through manner or not, along the reference trajectory,
the reference trajectory being adjacent to the reference trajectory and translated by a given distance from the reference trajectory; and
optionally, the reference trajectory is adjacent to the reference trajectory and translated by a given distance from the reference trajectory in the direction opposite to that of the trajectory, and
the given distances between two directly adjacent reference trajectories being such that the pulses of the laser beam, irradiating the sample to be machined on the reference trajectory, also irradiates, at least partially, the sample to be machined on the reference trajectory(s) which is or are directly adjacent to it; and
the steps (a) and/or (b) and/or, optionally (c) can be repeated until a part is machined and maintained in an amorphous state.

13. The method according to claim 1, wherein the amorphous metal alloy of the sample to be machined contains, in atomic percentage, more than 40% of Ni, Zr, Cu, Ti, Fe or Co or in which the amorphous metal alloy of the sample to be machined contains in atomic fraction more than 50% of the elements Ni and Nb.

14. The method according to claim 1 such that it is a method for producing a surface of a sample of amorphous metal alloy using a femtosecond laser,
the method comprising at least one step of irradiating with a laser beam a first surface of the sample so as to obtain a second surface whose roughness Ra is less than 400 nm; and in which:
the laser beam is pulsed, and
the duration of each pulse is less than 1000 femtoseconds, and
in which:
the amorphous metal alloy has:
a critical diameter less than 5 millimeters, and/or
a difference between the crystallization temperature and the glass transition temperature less than 60° C., and/or
a quotient of the difference between the crystallization temperature and the glass transition temperature and of the difference between the liquidus temperature and the temperature glass transition less than 0.12.

15. The method according to claim 1 such that it is a method for cutting a sample of amorphous metal alloy using a femtosecond laser, the method comprising at least one step of irradiating with a laser beam a first surface of the sample on one face so as to obtain a second face such that at each point of intersection of faces, the faces form therebetween an angle 90°±1.5°; and
the laser beam is pulsed, and
the duration of each pulse is less than 1000 femtoseconds, and
in which:
the amorphous metal alloy has:
a critical diameter less than 5 millimeters, and/or
a difference between the crystallization temperature and the glass transition temperature less than 60° C., and/or
a quotient of the difference between the crystallization temperature and the glass transition temperature and of the difference between the liquidus temperature and the temperature glass transition less than 0.12.

16. A method for manufacturing a part of amorphous metal alloy, including the steps of:
melting a mixture of metals to obtain a piece of alloy,
injecting the piece obtained into a mold and cooling the molded alloy with a cooling rate greater than a critical speed of crystallization of the alloy, to obtain a sample of amorphous alloy,
machining at least one surface of the sample according to the machining method of claim 1 to obtain a part of amorphous alloy according to a predetermined geometry,
optionally carrying out a finishing step on at least the machined surface of the sample.

17. A microcomponent of an amorphous metal alloy comprising at least one surface machined according to the method for producing a surface of claim 14.
